(19) United States
(12) Patent Application Publication
(10) Pub. No.: US 2011/0303693 A1
(43) Pub. Date: Dec. 15, 2011

(54) SINGLE OR MULTIPLE DISPENSE OF BEVERAGES FROM A BULK CONTAINER ON A REFRIGERATOR

(75) Inventors: BRIAN K. CULLEY, MOUNT VERNON, IN (US); JOHN D. KROONBLAWD, SAINT JOSEPH, MI (US)

(73) Assignee: WHIRLPOOL CORPORATION, BENTON HARBOR, MI (US)

(21) Appl. No.: 12/813,636

(22) Filed: Jun. 11, 2010

(51) Int. Cl. B67D 7/80; F23D 23/00

(52) U.S. Cl. 222/1; 62/98; 62/390; 222/146.6

(57) ABSTRACT

A system, apparatus, and method for single or multiple dispensing of beverages from a bulk container in a refrigerator includes a support or receiver for an interchangeable bulk liquid container on the inside of a refrigerated compartment door. A fluid conduit is adapted to be installed into the bulk container inside the refrigerator and extend through the door to a dispensing station accessible by a user from the exterior of the door. A pumping mechanism can be actuated to move liquid from the bulk container through the door to the dispensing station. Upon user choice or exhaustion of liquid from the bulk container, the conduit can be removed from the container, a new container substituted, the conduit reinserted, and a new source of single or multiple dispension is available at the exterior dispensing station of the refrigerator.

### BACKGROUND OF THE INVENTION

1. Field of the Invention

The present invention relates to dispensing of liquid from a bulk container in a refrigerator.

2. Related Art

One popular feature in many present refrigerators is an ice/water dispenser on the front of the refrigerator. Without opening the refrigerator door, which would let refrigerated air escape, a user can obtain materials or substances (e.g. ice or liquid) from the appliance. Typically, the user places a container at a dispensing location in the door. By either manual selection or automatic sensing, the selected material or substance is dispensed into the container. With respect to ice or water, the refrigerator is typically connected to an external water source and, thus, has an infinite supply available to it. The water is cooled or formed into ice inside the refrigerator.

Other beverages or drinks can be stored in individual containers inside the refrigerator if they are to be cooled. The user must open the refrigerator door and store the individual items in the refrigerator. The door must be opened and an item selected and then removed when desired. Those individual containers can be single serving or multiple serving. Examples would include but not be limited to quart, half gallon, or gallon containers of such things as milk, orange juice, lemonade, ice tea, etc. The user must remove the entire container, open or remove its closure, pour the desired amount out and reclose and return it to the interior of the refrigerator. This, of course, is time consuming and can be cumbersome, especially for full or nearly full large or bulk containers such as gallon size. The process also loses cool air by the opening(s) of the refrigerator door and thus requires additional energy to keep the interior temperature maintained.

Thus, a need has been identified in the art for a better way to dispense servings from a bulk container which must be refrigerated. Attempts exist to do so.

One example is U.S. Pat. No. 5,542,265 to inventor Rutland. It discloses a bulk container 15 inside the refrigerator on a refrigerator shelf, a fluid conduit from the interior of the container through the refrigerator door, and a retrofitted housing that hangs from the top of the refrigerator door. It includes a pump and control to allow a user to dispense servings from the internal bulk container to the exterior. This solution requires routing of the fluid conduit around and through a gap between the door and the refrigerator case. It also requires that the fluid conduit extend a substantial distance back to the bulk container sitting on the refrigerator shelf away from the door. It requires a housing 20 which hangs from and extends outwardly from the front of the refrigerator. It is therefore in the way and subject to being bumped by people walking by or using the refrigerator. This could damage the external housing or break or damage the tubing. It could possibly cause leakage of fluid onto the floor.

Another example is U.S. Pat. No. 5,956,967 to inventor Kim. It provides what it calls a cold drink container 100 inside the refrigerated compartment of the refrigerator. This is in addition to a water container 5 also inside the refrigerant compartment. An external water source line extends to both water container 5 and the cooled drink container 100. The patent describes the ability to provide a cool serving of water from cooled drink container 100 even if the larger water container 5 has been depleted or water in it is not sufficiently cooled. Alternatively the patent provides an opening in the top of cooled drink container 100 and discusses the ability of putting a different drink (other than water) inside it, which then can be dispensed at a dispensing station on the front door of the refrigerator. However, the system is relatively complex. It requires a water line to both the water container 5 and cool drink container 100. It additionally requires valves to turn those water lines on or off depending on which container 5 or 100 is selected to be dispensed. Also, the cool drink container 100 is a single serving container which must, in a separate action, be filled with water from the external water source or a liquid from another container or source.

Another example of an attempt is disclosed at Japan Publication JP10148460. It shows a container 16 that can be latched to the interior side of a refrigerator door. A housing 30 must be first attached to container 16. Housing 30 includes a latching mechanism and pump. When latched in place, a tubular conduit mates into a spigot or faucet 52 that extends from the front of the refrigerator door. By manual push button operation, the fluid in container 16 can be dispensed externally of the refrigerator. However, this requires a relatively complex, self-contained pump head to be installed on the container and then matingly latched to complementary structure built into the inside of the refrigerator.

A need has therefore been identified for an improvement in this area.

### BRIEF SUMMARY OF THE INVENTION

### Objects, Aspects, Features, or Advantages of the Invention

It is there a principle object, feature, aspect, or advantage of the present invention to provide an apparatus, method, or system which improves over or solves problems and deficiencies in the art.

Further objects, features, advantages, or aspects of the present invention include an apparatus, method, or system such as above described which:
a. Allows for a wide variety of different substances or materials to be stored in a refrigerator interior in bulk form yet be selectively dispensed in single or multiple servings.
b. Provides a highly flexible and adaptable system for single or multiple dispensing from a bulk container in a refrigerator.
c. Can be easily adapted to a variety of types of bulk container or interchangeable bulk containers.
d. Is economical and relatively non-complex.
e. Can be integrated with a conventional ice and/or water in-door dispenser.
f. Can hide or shelter most of its components from risk of bumping or user interference.
g. Does not take up significant refrigeration storage space.
h. Is easy to maintain.
i. Can be long-lasting and durable.

These and other objects, features, aspects, or advantages of the present invention will become more apparent with reference to the accompanying specification and claims.

### SUMMARY

In one aspect of the invention, a system comprises a refrigerator having a refrigerated interior compartment and a door covering the compartment, and an in-door dispensing station. A receiver or bin is built into the inside of the door and adapted to receive an interchangeable bulk liquid container. A fluid conduit extends through the door to the dispensing station. The bulk container end of the conduit is adapted to removably enter and be positioned at or near the bottom of the interior of the bulk container when in the receiver. A pumping mechanism is along the fluid pathway. A controller is adapted to instruct the pump to operate upon an actuation instruction. In this manner interchangeable bulk containers are conveniently stored on the inside of the door but can be easily accessed. Either single or multiple serving dispensions can be conveniently made at the built-in dispensing station on the exterior side of the refrigerator door.

In another aspect of the invention, a method of multiple or single dispensing of liquids from a bulk container inside a refrigerator comprises storing the bulk container inside a refrigerated compartment on the inside of a door of the refrigerated compartment; connecting, in fluid communication, the bulk container with a dispensing station of the refrigerator; and selectively dispensing single or multiple servings or doses from the bulk container through the refrigerator door.

Another aspect of the invention comprises a fluid conduit through the refrigerated compartment door of a refrigerator having a dispensing end at a dispensing station of the refrigerator and a bulk container end adapted for insertion into an interchangeable bulk liquid container. A receiver or support bin for the bulk container is built into or at the inside of the door. A pump is operatively positioned relative to the fluid conduit such that when the bulk container end of the fluid conduit is in the bulk container, a selected or instructed quantity of fluid can be pumped from the bulk container to the dispensing station of the refrigerator.

In another aspect of the invention, the fluid conduit can be removably secured or connected to an opening to the bulk container with a universal fit cap or closure. In one example, if the bulk container opening includes external threads, the universal fit cap has internal threads that can threadably mate onto the bulk container external threads. Certain bulk containers have standardized external threads. Therefore, one complementary cap effectively is universal to such bulk containers. This allows inter-change of bulk containers. The fluid conduit extends through the cap a distance such that it can be positioned at or near the bottom of the interior of the bulk container.

In another aspect of the invention, the distal end of the fluid conduit has a seal breaking configuration that allows it to pierce or puncture a seal or frangible member over the opening to the bulk container and extend to at or near the bottom of the interior of the bulk container.

### BRIEF DESCRIPTION OF THE DRAWINGS

FIG. 1 is a reduced-in-scale perspective view of a refrigerator having freezer and refrigerated compartments, a dispensing station in a door of the refrigerator, and a single or multiple dispense option from a bulk container inside the refrigerator according to one exemplary embodiment of the present invention.

FIG. 2 is similar to FIG. 1 but shows the refrigerator door open and a bulk container in operative position according to the exemplary embodiment.

FIG. 3 is a simplified diagrammatic view of the bulk container and its integration into the dispensing station of the refrigerator of FIGS. 1 and 2.

FIG. 4 is a highly simplified schematic of the basic bulk dispensing system according to the exemplary embodiment without the interchangeable bulk container.

FIG. 5 is similar to FIG. 4 but shows the interchangeable bulk container (shown partially in vertical section) in supported position in a bin or receiver on the refrigerator door as well as illustrating preparation for hookup to the dispensing system of the exemplary embodiment.

FIG. 6 is similar to FIG. 5 but shows complete hookup to the exemplary dispensing system.

FIG. 7 is an enlarged sectional view of a universal cap embodiment that can be used with the exemplary embodiment of FIGS. 1-6.

FIG. 8 is an alternative embodiment for a universal cap.

FIG. 9 shows an optional or alternative configuration for a dispensing system according to the present invention, namely the fluid conduit from bulk container to dispensing station can have a section that can be detached for easier connection to the dispenser or the bulk container and for removal for cleaning or replacement.

FIG. 10 is an alternative embodiment for the bulk container end of the fluid conduit of the dispensing system according to the invention, namely an end configuration that can puncture or penetrate with relatively little manual force a puncturable or frangible seal over the mouth of the bulk container (shown partially in vertical section)

FIG. 11 schematically illustrates the embodiment of FIG. 10 in the fully installed position, penetrating through the seal and extending into the interior of the container.

FIG. 12 is an alternative embodiment of the present invention showing a universal stopper that can be used in conjunction with the fluid conduit for dispensing from a bulk container (shown partially in vertical section).

FIG. 13 is an enlarged isolated view of the dispensing tube withdrawn from the stopper.

### DETAILED DESCRIPTION OF EXEMPLARY EMBODIMENTS OF THE INVENTION

### Overview

For a better understanding of the invention and its aspects, a detailed description of one or more embodiments will now be set forth. It is to be understood that these detailed descriptions are neither exclusive nor inclusive of all forms the invention can take, but are merely illustrative.

The exemplary embodiments will be described in the context of a bottom freezer refrigerator having an upper refrigerated compartment with doors that are closable over that compartment. A conventional ice and/or water dispensing station is built into one refrigerated compartment door and has ice and/or water on demand via conventional components. The refrigerated compartment has shelves and supports for storing a variety of food products or beverages and the like. It is to be understood, however, that aspects of the invention can be applied in analogous ways to different refrigerator configurations and styles.

Furthermore, many of the exemplary embodiments will be described in the context of a bulk container of liquid such as beverages of the type of a plastic gallon milk or juice container having a standard sized externally threaded neck and complementary internally threaded cap as a closure. However, it is to be understood that aspects of the invention can be applied in analogous ways to other bulk containers including those which are standardized or off-the-shelf in commercial contexts or to custom or original manufactured containers of the same or different sizes and/or the same or different openings or closures.

### System

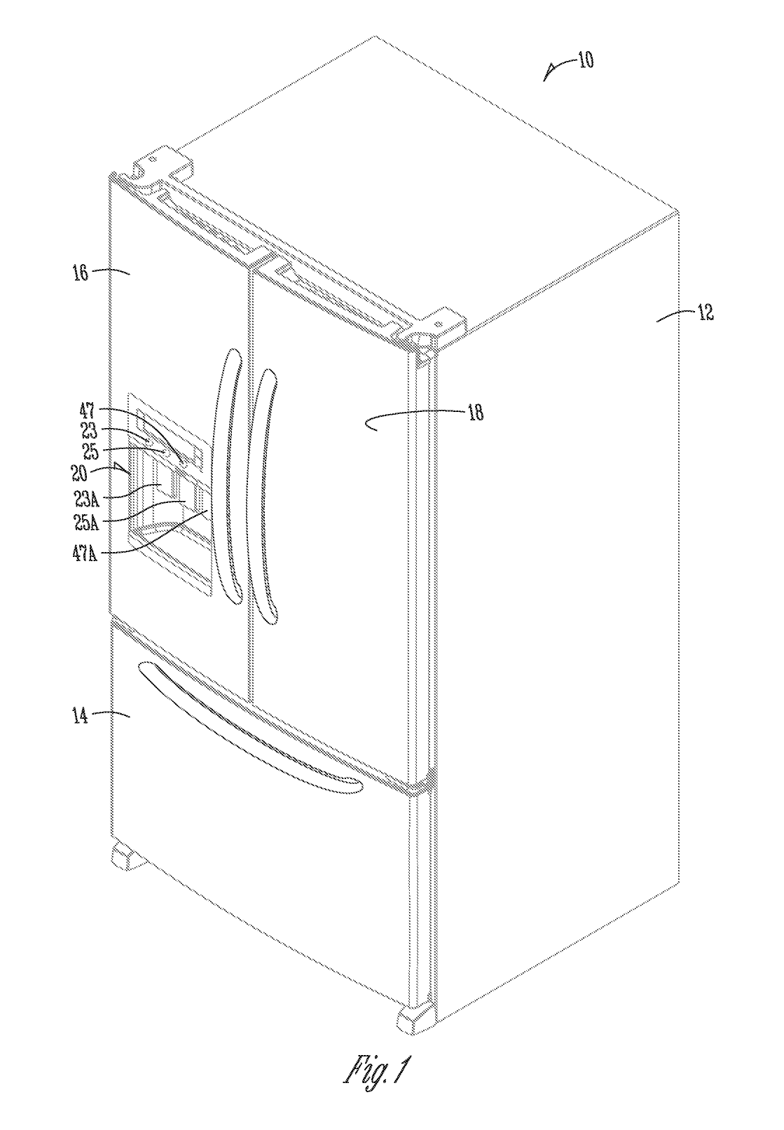

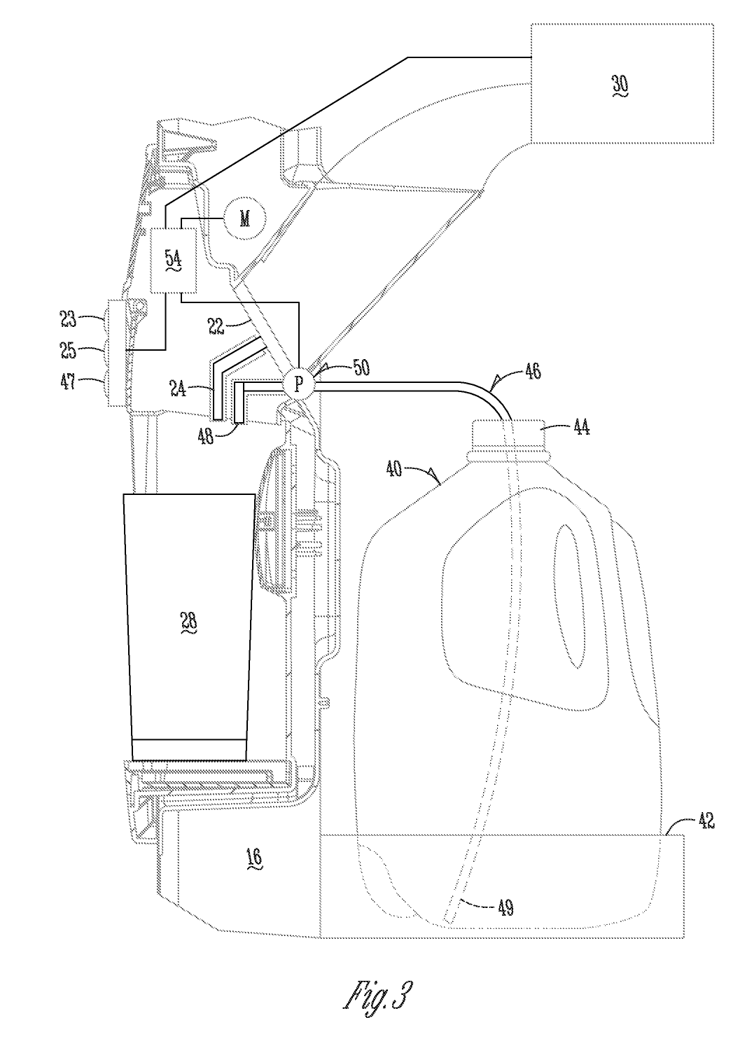

FIGS. 1-3 show a bottom freezer refrigerator 10 having an insulated cabinet 12, an openable freezer door 14, a left side refrigerated compartment openable door 16, and a right side refrigerated compartment openable door 18. A dispensing station 20 is built-in to door 16 such that a user can place a suitable container (glass or dish) into the receiving station cavity and operate control 23 to dispense ice from ice chute 22 (see FIG. 3) into the container or push control 25 to dispense water from water line 24 (see FIG. 3) into the container. Alternatively or in addition, manually pushable paddles 23A and 25A could instigate ice or water dispension. Here the dispensing station includes ice and water dispensing options, but they are not necessarily required.

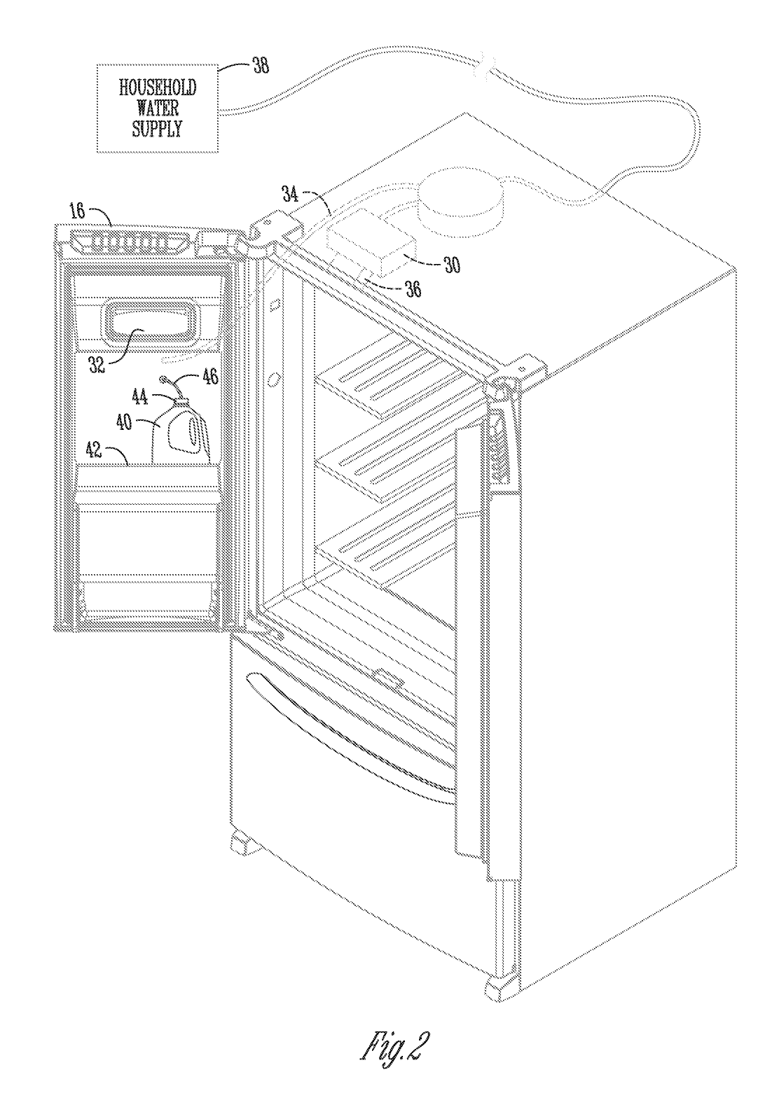

As illustrated at FIG. 2, refrigerator 10 would be operatively connected to a household water supply 38 which provides pressurized water to a water line 34 that supplies water to either ice maker 30 or water line 24. Such features are well known and in a wide variety of commercially available refrigerators. Further details are not needed for such well known functions.

In addition to ice or water from the household water supply, refrigerator 10 includes a user-selectable option of a beverage through conduit 46 (see FIG. 3) by actuation of control 47 at or near the dispensing station 20. The user can select this different selection in the same manner as ice or water would be selected. Alternatively or additionally, a paddle 47A of conventional type and operation could allow a user to move a glass to the dispensing station and against paddle 47A to instigate dispension of this third choice.

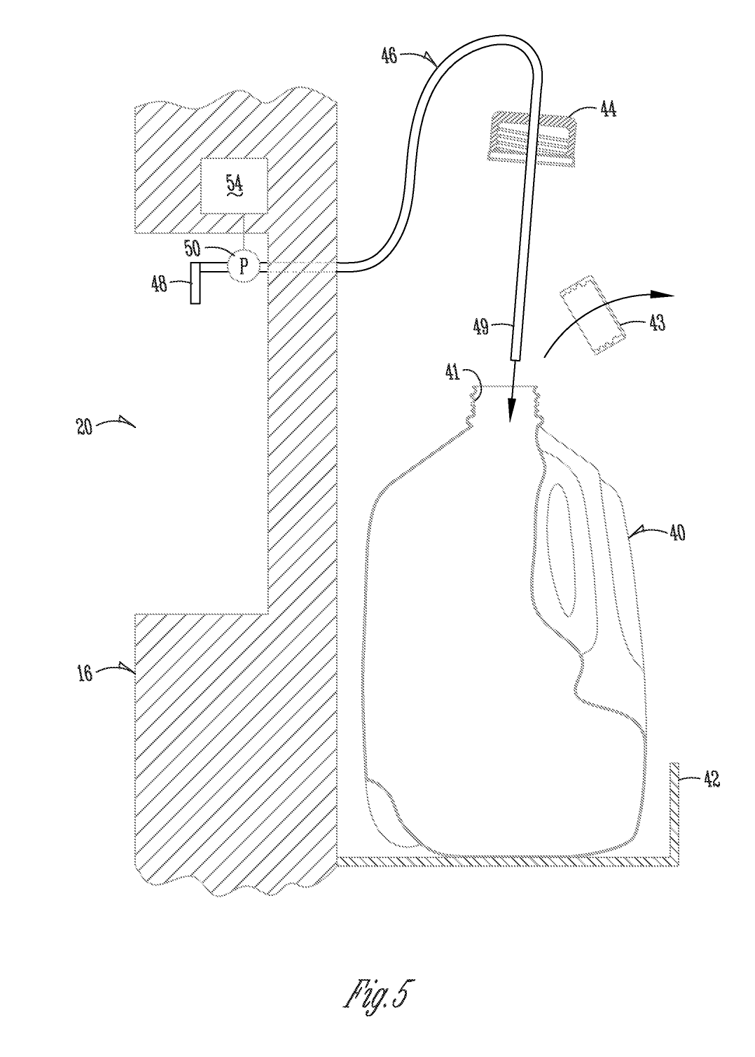

FIG. 2 illustrates that tube 46 is operatively in fluid communication with a bulk beverage container 40 stored in a bin or receiver 42 on the inside of refrigerated compartment door 16. Tube 46 extends through the opening in bulk container 40 a sufficient distance such that substantially all or most of the contents of container 40 are accessible by that end as fluid is dispensed from container 40. See, for example the schematic illustration of FIG. 6 as one example.

The opposite end of conduit 46 extends into and through door 16 and terminates in a dispensing end 48 (see FIG. 3) that is positioned to discharge fluid into a container (e.g. glass 28) that would fit into dispensing station 20.

As illustrated in FIG. 3, a pump 50 is operatively installed along conduit 46 and can be electrically connected to a controller 54 that can be programmed to issue a pumping instruction when the user actuates control 47 on the front of refrigerator 10. Such control through a controller 54 connected to control 47, and an appropriate electrical or electronic connection to pump 50, can be any of a variety of conventional combinations. It could be similar to how controller 54 would actuate an ice maker motor to move ice to ice chute 22, or actuate a valve to release water in water line 24 to a container 28 such as are common in many existing refrigerators.

In the example of FIGS. 1-3, bulk container 40 is a plastic one gallon milk jug having a threaded neck 41 and a threaded closure 43 (FIG. 5) that is purchasable off-the-shelf at food stores, convenience stores, and other commercial locations. It holds multiple servings of milk (thus for these purposes one example of a bulk container). It can have a handle or grip to facilitate easier carrying by hand. It is relatively economical. The size and threading of neck 41 is typically standardized (e.g. 38 mm diameter plastic screw or snap-screw lids or closures). Bulk container 40 is therefore easily accessible and interchangeable. It is also disposable or recyclable.

As can be appreciated from FIGS. 1-3, refrigerator 10 therefore adds another user selection at dispensing station 20. The user can select dispension of a finite quantity but bulk-contained beverage; different than water from the unlimited household water supply 38. By appropriate operation of control 47, the user can select either a small amount from the bulk container 40, or a large amount. There is no required mixing or complex valving. Pump 50 is simply operated until a desired amount from bulk container 40 is dispensed in the user's glass 28. Bulk-contained beverage is available for single serving or dose, or multiple serving or dose dispension, at the conventional refrigerator ice and/or water dispensing station. There is no add-on that extends outward of or must be independently mounted to the refrigerator door.

Support bin or receiver 42 can be a bin or shelf built into or mounted on the interior of door 16. Other components of the refrigerator, such as shelves or other structures in the refrigerated compartment would be appropriately configured to allow door 16, with bin 42 and bulk container 40 in place, to fully shut. FIG. 2 shows receiver 42 as a full door shelf (having room for other bulk containers or other stored items). Alternatively, receiver 42 could be sized to matingly receive just one bulk container 40 (which could help guide the user to properly place container 40). Receiver 40 could take many forms and embodiments.

By reference to FIG. 3, it can be seen that an economical yet robust fluid conduit 46 (plastic) and a universal cap 44 can be configured to extend from the inside of door 16 a sufficient distance such that end 49 of tube 46 extends to at or near the bottom of container 40 while allowing cap 44 to be turned down on threaded neck 41 of container 40. Tube 46 extends through the door directly to the dispensing station 20. Pump 50 can be built into door 16. Alternatively, it can be positioned elsewhere along path of conduit 46. Electrical connections to controller 54 and from control 47 to controller 54 can be built-in or integrated in similar fashion to existing electronically controlled components of refrigerators with the ice dispenser station.

Thus there is minimal modification to the refrigerator. The space taken up by the bulk dispension option is minimized, and there is no additional structure extending forwardly of the front vertical plane of refrigerator 10. Nor does tubing or wiring need to be routed externally and then through gaps between door and refrigerator case or the like.

### Operation

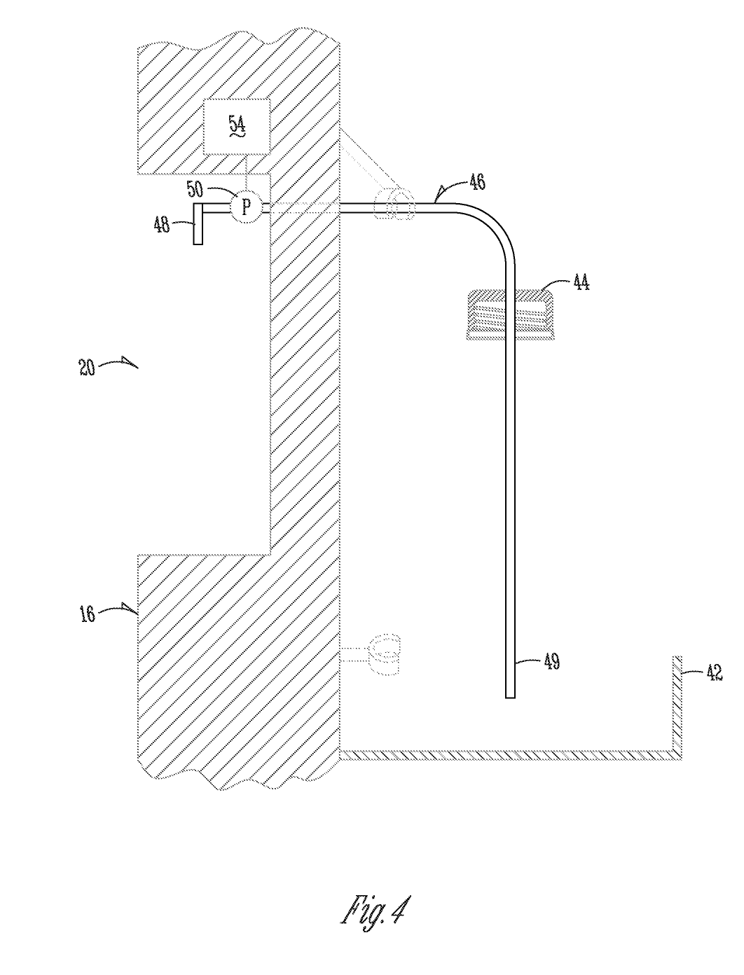

By further reference to the simplified schematics in FIGS. 4-6, and with reference to FIGS. 1-3, the system described above can be operated as follows.

Refrigerator 10 would come with the bulk dispensing system of FIG. 4 installed. Bin 42 would be at the interior of door 16. It would be made of materials and configured to support at least one-gallon plastic milk jug type bulk containers for a normal foreseeable life of such refrigerators. Bin 42 would be configured, in one example, to allow the user to easily set the container matingly into a receiver that would hold it securely in place over normal opening and closing of door 16, yet allow easy removal.

In one form, tube 46 could be a continuous flexible tube all the way between ends 49 and 48 with pump 50 operatively disposed at a position there along. An intermediate section of tube 46 would extend through a pre-manufactured opening through door 16 which would be subsequently sealed and insulated. Universal cap 44 is installed along tube 46. In this example, cap 44 can rotate about tube 46 but also can be slid along tube 46. As can be appreciated by those skilled in the art, the manner in which tube 46 is routed through door 16 can vary. Also, there could be other structure associated with tube 46. One example might be an arm or cantilever (see dashed lines) on the inside of door 16 that helps support tube 46 (e.g. holds the generally horizontal section extending from door 16 and allows the remainder to hang generally vertically). Another example might be a clip, hook, or holder (see dashed lines at level of end 49 of tube 46) on door 16 to temporarily hold (e.g. by snap-fit) tube 46 nearer or at its end 49 when tube 46 is not inserted into a bulk container 40). There could also be structure integrated into or added to tube 46. One example might be a sleeve or support added at the bend from the horizontal to vertical sections to add strength or support. Another example would be an accordion or bellows-style tube structure at the bend to facilitate repeated bending, pivoting, and even some ability to longitudinally expand and contract tube 46. Another example could be a releasable connection along tube 46 to dis-connect and re-connect sections (e.g. for cleaning, replacement, etc.) (see FIG. 9).

As illustrated in FIG. 4, the system here would be ready for use. It could be innocuously stored in that configuration if a bulk container 40 is not hooked up to it. As can be appreciated, there could be some sort of clip or attachment on the interior of door 16 to snap or hold the free distal end 49 from movement when in that position (see FIG. 4).

To use the system, bulk container 40 would have its normal closure 43 unscrewed and removed (e.g. a snap-screw or screw lid) (see FIG. 5). Container 40 would then be seated into bin 42 (FIG. 5). Distal end 49 of tube 46 would be inserted through the now open neck of container 40. As shown in FIG. 6, end 49 would be moved to at or near the bottom of container 40 and closure cap 44 screwed onto neck 41.

To dispense a drink from bulk container 40, a user would place container 28 (e.g. a glass) under end 48 of tube 46 at the conventional ice/water dispensing station on the exterior of door 16 (without having to open door 16) and actuate the appropriate control 47 to actuate pump 50 to dispense liquid from bulk container 40 into container 28. As can be appreciated, user-control could allow dispension continuously until all the content essentially of container 40 is pumped out. Alternatively, a controller or other mechanism might be configured to only allow a limited dose or serving to be pumped out per actuation of a control 47. In other words, as a fail safe, the system might dispense only a single serving or a sub-set of the entire volume of bulk container 40 at one actuation of pump 50. The user could get multiple dosages by receiving a first dose and then reactivating control 47 for the second dose, and so on.

There are other control features, such as are known in the art, that can be used with the system. One would be some type of sensor that would, for example, sense the presence of container 28 at dispensing station 20 underneath end 48 and automatically actuate pump 50. Another example would be a sensor that would sense when container 28 is nearing full and shut off pump 50 automatically. Another example could be some type of sensor that would sense when container 40 is nearing empty to alert a user on the exterior of the refrigerator that a new container 40 should be changed in. This could be via some sort of optical sensor or float in the distal end 49 of tube 46 or other fluid level sensors such as are known in the art. The sensor could communicate to some sort of signal such as an LED or other alarm that could be perceived by a user when door 16 is closed. Another example would be some sort of a weight sensor which would be calibrated to issue an alarm when container 40 is nearing empty.

Thus, operation of the system allows a user to select the desired type of beverage (milk, orange juice, ice tea, lemonade, or any beverage commercially available in such a container 40), and install it for multi-serving capability of that beverage at the dispensing station 20. Alternatively, of course, a user could use the standard off-the-shelf milk gallon jug container but insert their own customized beverage and then install it in the system. An example would be mixing or brewing ones own ice tea, lemonade, cool-aid, or other powdered or concentrated mixes with water or other liquids. And, of course, the manufacturer of system 10 or an accessory manufacturer could design custom bulk containers for container 40 instead of using the ubiquitous one gallon milk jug plastic container. For example, a metal or insulated composite container could be utilized with the same type of threaded neck as the one gallon milk container (or could have some other type of structure at its opening that would function with a complementary cap or closure on tube 46). Alternatively, it could have a different neck or opening. Such a container could be color-coordinated with the refrigerator or the kitchen décor of the user. Other aesthetic features are possible with such a customized bulk container. As can be further appreciated, tube 46 could also be ornamented, colored, or configured in aesthetic ways.

### Options and Alternatives

It will be appreciated that the foregoing examples address one or more of the stated objectives of the invention but are only a few examples of forms aspects of the invention can take. This description is neither limiting nor inclusive of all forms and embodiments the invention can take. Variations obvious to those skilled in the art will be included within the invention which is defined solely by the claims appended hereto.

For example, the materials, configurations or components, and specific scale and dimensions of components can vary according to need and desire. By way of one example, pump 50 can be any of a number of pumps. One example is a Quantex pump such as is commercially available from Quantex Arc Ltd., 85 Richford Street, London W67HJ England. An example of such an elastomeric diaphragm pump, is disclosed at published PCT application WO 2006/027548, incorporated by reference herein. Such a pump is relatively inexpensive to the extent it is sometimes described as being disposable. Yet it is effective and efficient at pumping liquids in this context. At very low speeds there is literally no leakage of fluid but emptying is efficient and highly accurate. It can handle fluids such as milk, juices, and the like. It also prevents degradation of contents in its pumping path as it presents an aseptic barrier when not rotating.

Some attributes of the Quantex pump are as follows. It is relatively inexpensive and can be considered disposable in some contexts. It has a plastic outer housing, an interior central rotor with indents. The fluid conduit passes through one side of the housing and defines an input and an output to the housing. An elastomeric diaphragm is built-in along the fluid conduit. The rotor indents pick up fluid from the input side and transports it around the housing to the output side. The flexible diaphragm pushes fluid into the output side, emptying each indent as it rotates by. Because the indents running against the housing form a fixed volume, the emptying is efficient with high accuracy. Flow rate is controlled by rotation rate. An electric motor can be operated to turn the rotor at a desired speed. The size of the pump can be relatively small (e.g. 22-35 mm in (largest dimension).

As can be appreciated, in the exemplary embodiments, pump 50 must be able to “self-prime”. In other words, it must have the capability of pulling liquid from an elevation lower than it is out of the bulk container, through the door, and to the dispensing end.

By further example, depending on size and type of pump 50, it could be positioned in door 16, in or close to dispensing end 48 of tube 46, or near to container end 49.

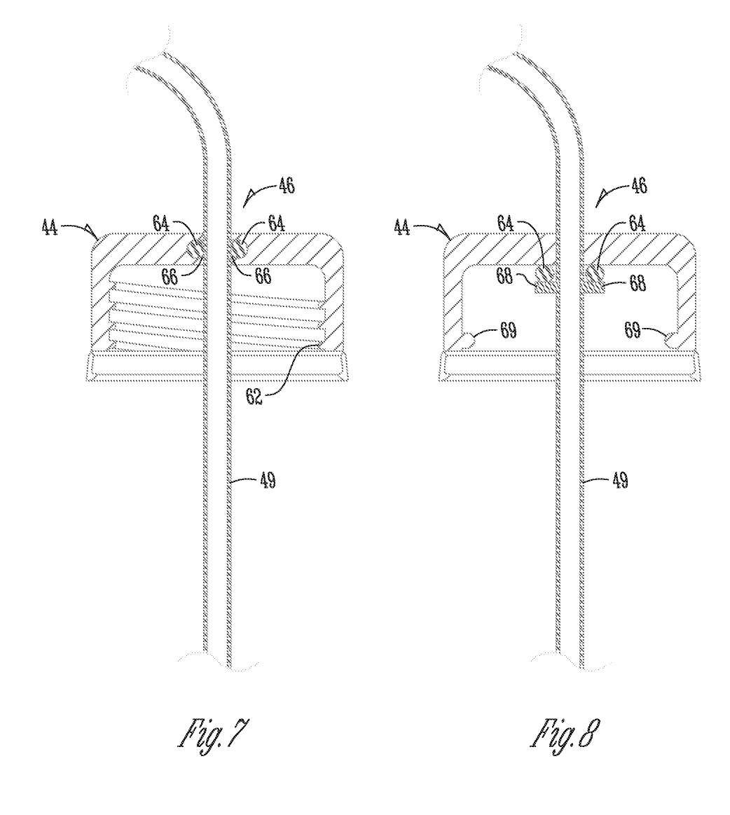

By further example, universal cap 44 can take different embodiments. Likewise, some sort of self-sealing bottle closure could be utilized instead of stopper 80. One example is an Andwin Scientific (Addison, Ill. USA) Staysafe™ Self Sealing Bottle Closure. It could be interference fit or threaded or snapped onto the neck of container 40. This would allow a blunt ended distal end 49 of tube 46 to be repeatedly inserted and retracted but self seal around tube 46. A further example is in U.S. Pat. No. 3,392,859, incorporated by reference herein, which could be a snap cap like cap 44 of FIG. 8 with a perforable, self-sealing container closure that would be adapted for such things as blunt ended distal end 49 of tube 46 to be passed through. Therefore, there would be no requirement that cap 44 have to be rotated or threaded onto container 40.

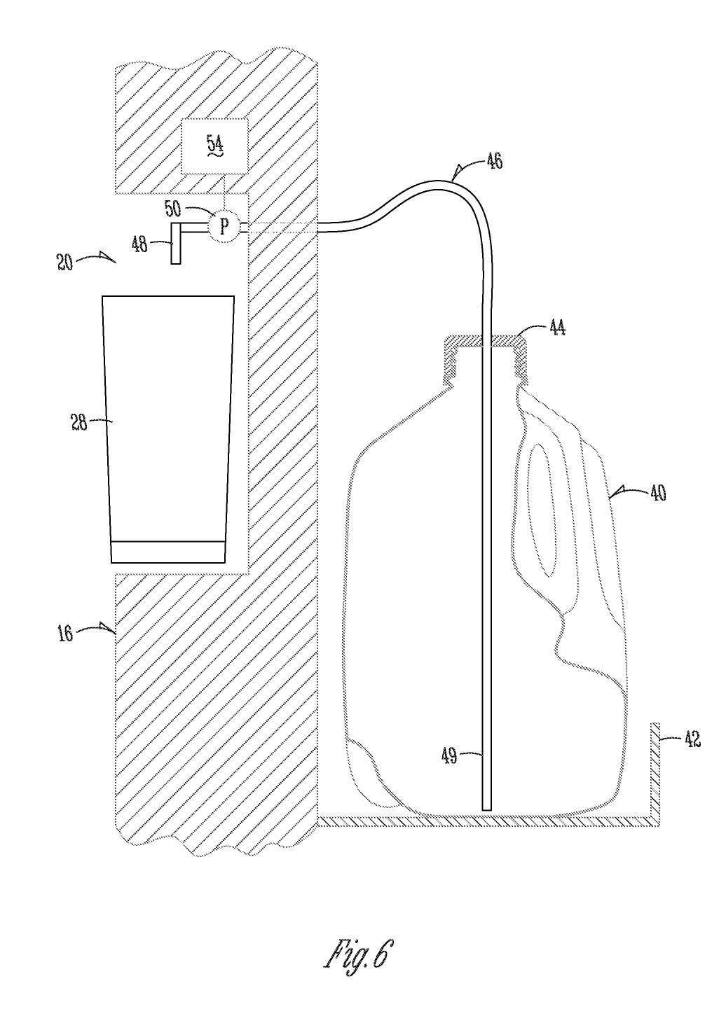

FIG. 7 shows one form of a universal cap 44. Although not necessarily required, universal cap 44 can be configured to be able to rotate around tube 46. One way to do so is to have an opening in cap 44 through which tube 46 can pass. An O-ring or other resilient elastomeric member 64 can be held in a channel or track 66 around the opening in cap 44. Cap 44 and O-ring 64 can then be slid longitudinally along the exterior of tube 46 to allow easy adjustment of end 49 down to the bottom of container 40 but also allow rotation of cap 44 around the longitudinal axis of tube 46. This can be while O-ring 64 at least substantially seals the space between cap 44 and the exterior of tube 46. FIG. 8 shows an alternative embodiment. An O-ring 64 or other sealing member could be captured between cap 44 and flange 68 built into or fixed along the exterior of tube 46. This would allow cap 44 to rotate around tube 46 but provide at least a substantial seal. FIGS. 7 and 8 show but two embodiments of a structure that can in a relatively non-complex, economical, yet flexible manner assist in allowing tube 46 to be inserted into a bulk container 40 and closure 44 connected to the container. FIG. 8 also shows that instead of internal threads in cap 44, there might be simply a boss or flange 69 that would allow closure 44 to snap fit onto the neck of a container as opposed to threadably fit. This could dispense with the requirement that cap 44 have to rotate around the axis of tube 46 to be connected.

Another option is shown at FIG. 9, conduit 46 could have one portion built into door 16 to dispensing end 48 but then have some sort of connection 72 that allows removal of the remainder of tube 46. One example would be complementary male and female threaded connections. Another would be a snap-fit. This could facilitate easier insertion into bulk container 40 and/or removal for cleaning. An alternative would be that the entire tube 46 could be slid through door 16 with some sort of mechanical guide and limit to position end 48 in an appropriate position in dispenser 20. When cleaning is desired (for example when each changeover of container 40 is accomplished), the entire tube 46 could be removed and washed, including in a dishwasher.

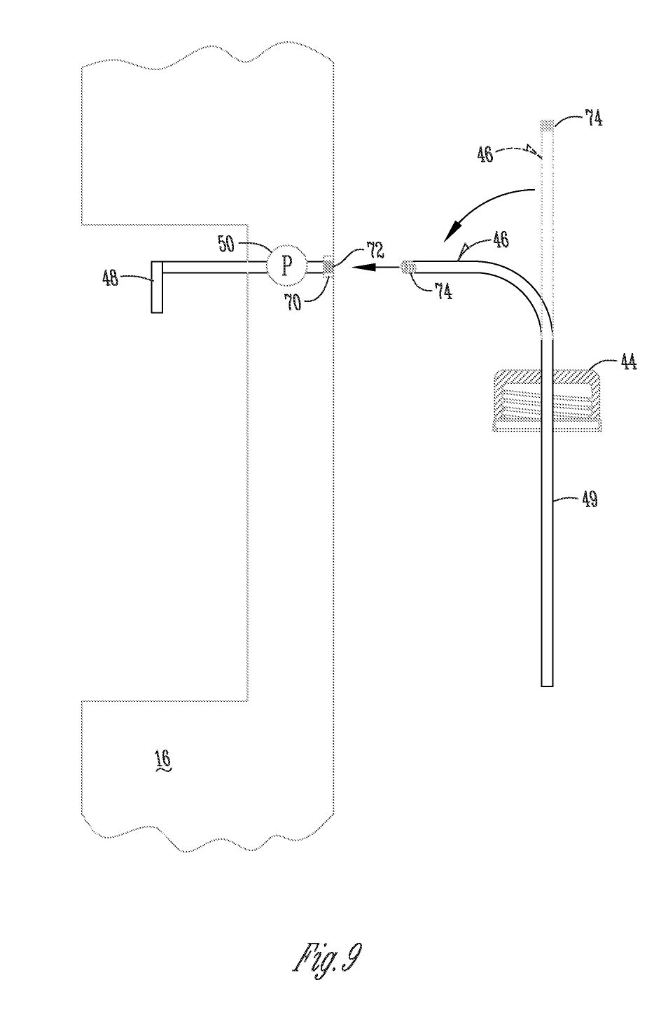

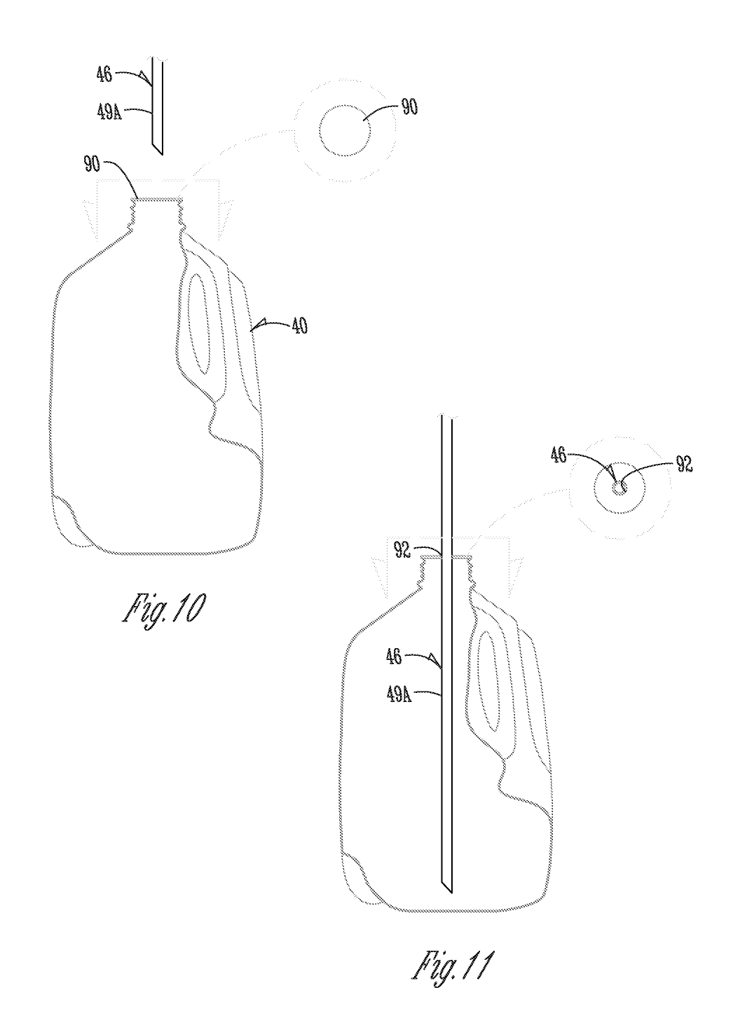

By referring to FIGS. 10 and 11, an additional or optional feature could be a distal end 49A of tube 46 with a configuration or functional ability to break through through a closure on container 40. An example would be the thin foil seal 92 that is adhered over the mouth of many one gallon plastic milk jugs so that even when the closure cap 43 is removed, the contents are sealed. End 49A could have a beveled or slanted profile that would effectively, without requiring too much manual force, puncture such a metal foil seal and then allow tube 46 to be extended down to at or near the bottom of container 40. This embodiment could operate similarly to off-the-shelf juice boxes that come with a straw with a beveled or slant/cut end, where the user uses that end to puncture a metal foil and slide the straw down into the juice box. Of course, the end 49A would likely be larger and more robust for a one gallon milk jug. FIGS. 10 and 11 show, respectively, end 49A before puncturing seal 90, and then after puncture. Like the juice box, a substantial seal can still exist at point 92 between the foil seal that has been punctured by tube 46.

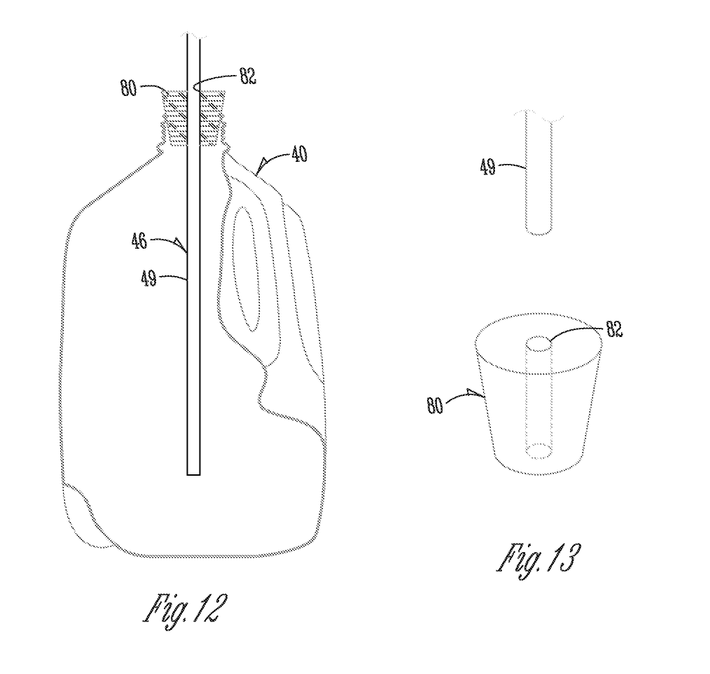

A still further possible alternative is shown in FIGS. 12 and 13. Some sort of stopper 80, such as are widely known in laboratory settings, having a central aperture 82, could have tapered cross section. Tube 46 can be pushed through (e.g. by interference fit) central opening 82 to the bottom of container 40 and stopper 80 slid along tube 46 but then wedged into the neck of container 40. Stopper 80 could be made of elastomeric materials such as rubber or synthetic rubber or other similar materials that could operate to present at least a substantial seal and/or a substantially robust support of tube 46 in place.

The exemplary embodiments interact with a conventional in-door ice and/or water dispensing station for a refrigerator. Alternatively, a system according to one aspect of the invention could comprise a dispensing station that is dedicated to the bulk dispension and does not include other dispensing options such as ice or water. Furthermore, other possible embodiments according to aspects of the invention could be an analogous bulk dispensing system or method to that described for a conventional full-sized household refrigerator but implemented in another appliance. One non-limiting example is a counter-top or smaller scale refrigerator.

Another possible option would be more than one bulk container on the interior side of the refrigerator door. A receiver could be configured to hold one, two, three, or more. The contents of any of the plural bulk containers could be dispensed similarly to that disclosed in the description earlier. The user could select a bulk container, insert the conduit into the bulk container, and pump from that container. The conduit could be switched to a different container for a different beverage choice or other reason.

Alternatively, each of the plural bulk containers could have its own tube or conduit. A valve could allow the user to select a container, and a single pump could dispense from that selected container. Alternatively, each of the plural containers could have its own conduit and pump, and the user could dispense from any container.

An option with or without multiple bulk containers would be a collection or kit of multiple caps. The multiple caps could be a variety of standard sizes so that the user could select the bulk container style (from a variety of styles with standard-sized openings), and install on the tube or conduit the complementary cap from the collection or kit, and then insert the tube or conduit into the bulk container and secure the cap. If another container is desired, switch-over is easy. If a different cap is needed for the next container, it is quickly and easily switched onto the tube or conduit. Non-limiting examples of standard caps/containers would be two liter bottles, ½ gallon carton-style juice containers, and one gallon milk jugs. Similarly, a collection of different size stoppers, snap-fit caps, or other container closures could be provided or be available to the user for use with, for example, non-standard or non-threaded container openings.

Another option would be a measured fill feature. Instead of the pump dispensing from the bulk container until a manually-activated control (e.g. paddle, lever, push-button, touch-screen icon) is released, a user-specified amount of their choice could be dispensed by a single (even momentarily) user-selection (via, e.g. a digital menu, a plurality of buttons, etc.). Such could be attended or unattended. For example, the user could select a volume for dispension, and the system could be calibrated to automatically dispense that volume. The user could literally walk away after the selection and come back to retrieve that glass that has been automatically filled with the user-selected volume.

What is claimed is:

1. A system for single or multiple dispension of liquid from a bulk container in a refrigerator comprising:
a. a refrigerator body including a refrigerated compartment;
b. a dispensing station in a door to the refrigerated compartment;
c. a bulk fluid container receiver on the interior of the door;
d. a fluid conduit having a dispensing end positionable at the dispensing station and extending through the door to an opposite end;
e. the opposite end of the conduit having a configuration adapted for insertion into a bulk fluid container when operatively positioned in the receiver;
f. a pump associated with the fluid conduit adapted to pump fluid from the container end of the fluid conduit to the dispensing end of the fluid conduit.

2. The system of claim 1 wherein the bulk fluid container is a standard-sized, standard-threaded opening bulk fluid container.

3. The system of claim 2 further comprising a universal cap along the fluid conduit having a mating complementary closure mechanism for the standard-sized, standard-threaded opening of the bulk fluid container.

4. The system of claim 1 wherein the container end of the fluid conduit comprises a configuration adapted for breaking a seal.

5. The system of claim 1 wherein at least the container end of the fluid conduit is detachable and reattachable to the remainder of the fluid conduit.

6. The system of claim 1 wherein the fluid conduit and pump are removable and disposable.

7. A method of single or multiple dispensing of beverages from a bulk container in a refrigerated compartment comprising:
a. storing a bulk beverage container on the inside door of a refrigerated compartment of a refrigerator;
b. selectively moving liquid from a bulk container through the door to a dispensing station accessible by a user on the exterior of the door.

8. The method of claim 7 further comprising moving liquid from the bulk container to the dispensing station upon user-instigation.

9. The method of claim 7 further comprising presenting at least one additional dispensing option at the dispensing station.

10. The method of claim 9 wherein the at least one additional dispensing option comprises:
a. ice; and
b. water.

11. The method of claim 10 wherein any of the dispensing options are available by user-instigation.

12. The method of claim 7 wherein the bulk container is interchangeable.

13. The method of claim 12 wherein the bulk container has a standardized closure.

14. The method of claim 13 further comprising a closure associated with the conduit that is universal to the standardized closure.

15. A refrigerator comprising:
a. a refrigerator body including a refrigerated compartment;
b. a dispensing station in a door to the refrigerated compartment having a space into which can be inserted and removed a glass or other container;
c. a dispensing selector at the dispensing station, the dispensing selector including a manually-selectable input;
d. a bulk fluid container supported on the interior of the door;
e. a fluid conduit having a dispensing end positioned at the dispensing station and an opposite end inserted into the bulk fluid container;
f. a pump associated with the fluid conduit adapted to pump fluid from the container end of the fluid conduit to the dispensing end of the fluid conduit upon instruction from the dispensing selector.

16. The refrigerator of claim 15 further comprising one or more other dispensing selectors at the dispensing station.

17. The refrigerator of claim 16 wherein the one or more other dispensing selectors are associated with:
a. an ice maker and chute to provide ice to the dispensing station; and
b. a water source and conduit to provide water to the dispensing station.

18. The refrigerator of claim 15 wherein the bulk fluid container comprises a one-gallon milk jug with screw lid or snap-screw lid.

19. The refrigerator of claim 18 wherein the pump is mounted in the door.

20. An apparatus for multiple dispensing choices from an appliance comprising:
a. a refrigerator comprising a refrigerated food compartment;
b. a door closable over the refrigerated food compartment;
c. an in-door ice and/or water dispensing station built into the exterior of the refrigerated food compartment door;
d. a bulk fluid container support on the interior of the refrigerated food compartment door;
e. a fluid conduit extending through the door and comprising first and second ends;
f. the first end of the fluid conduit positioned at the dispensing station on the exterior of the refrigerated food compartment door;
g. the second end of the fluid conduit extending from the interior of the refrigerated food compartment door and adapted for insertion into a bulk fluid container;
h. a pump along the fluid conduit adapted to pump fluid through the fluid conduit;
i. a controller operatively connected to the pump and adapted to operate the pump upon an activation instruction; and
j. an activation control at the dispensing station operatively connected to the controller adapted to cause the controller to issue the activation instruction.

21. The apparatus of claim 20 wherein the pump is built into the refrigerated food compartment door.

22. The apparatus of claim 20 wherein the controller is built into the refrigerator.

23. The apparatus of claim 20 wherein the fluid conduit is a continuous flexible tube.

24. The apparatus of claim 23 wherein the pump comprises a rotary pump comprising a rotor with indents inside an outer housing that pick up fluid from an input side of the fluid conduit into the pump and transports fluid around the housing to an output side of the fluid conduit, and including a diaphragm on the housing that pushes fluid into the output side, emptying the indents.

25. The apparatus of claim 24 wherein the pump is reversible.

26. An apparatus for dispensing fluid from a refrigerator having a refrigerated food compartment coverable by a door comprising:
a. a bulk fluid container support on an interior side of the door;
b. an in-door dispensing station on the exterior side of the door;
c. a fluid conduit and pump between the bulk container support and the in-door dispensing station;
d. so that fluid from a bulk fluid container placed in the bulk fluid container support in the refrigerated food compartment can be dispensed at the dispensing station on the exterior side of the door without opening the door.

27. The apparatus of claim 26 wherein the pump is in the door.

28. The apparatus of claim 27 further comprising an actuator operatively connected to the pump to actuate the pump.

29. The apparatus of claim 28 further comprising a user-operable control to selectively instruct the actuator to actuate the pump.

30. The apparatus of claim 26 wherein the bulk fluid container support supports a plurality of bulk fluid containers.

31. The apparatus of claim 30 wherein the fluid conduit comprises plural fluid conduit branches, each branch a digital to be communicated to one of said plurality of bulk fluid containers.

32. The apparatus of claim 31 further comprising either a valve to select between different conduit branches or a pump for each conduit branch.
